(19) United States
(12) Patent Application Publication
(10) Pub. No.: US 2011/0095159 A1
(43) Pub. Date: Apr. 28, 2011

(54) Snap link mount with conformable base

(76) Inventor: Jeffrey D. Carnevali, Seattle, WA (US)

(21) Appl. No.: 12/589,744

(22) Filed: Oct. 28, 2009

(51) Int. Cl. F16M 11/14

(52) U.S. Cl. 248/372.1

(57) ABSTRACT

A mounting apparatus having interconnectable articulated elements, the mounting apparatus having a mounting base that is structured for substantially conforming to a surface external of the mounting apparatus; a connector base having a mounting plate; and an interconnectable articulated ball-and-socket joint between the mounting base and the connector base, the ball-and-socket joint having a substantially spherically convexly curved male ball connector, a complementary substantially spherically concavely curved female socket adapted to receive the male ball connector rotatably therein, and a resilient biasing member compressible between the male ball connector and the female socket.

### FIELD OF THE INVENTION

The present invention relates generally to flexible mounting apparatus and particularly, to molded plastic interconnecting ball-and-socket elements in combination with a universally mountable base interconnected thereto.

### BACKGROUND OF THE INVENTION

Flexible mounting apparatus formed of interconnecting ball-and-socket elements are generally well-known. Such apparatus are easily adjustable and widely used for holding relatively light external loads.

However, known interconnecting ball-and-socket elements are prone to slippage and fail to reliably retain a set configuration over time.

### SUMMARY OF THE INVENTION

The present invention is a mounting apparatus having interconnectable articulated elements. The mounting apparatus includes a mounting base structured for substantially conforming to a surface external of the mounting apparatus, and a connector base having a mounting plate. An interconnectable articulated ball-and-socket joint is positioned between the mounting base and the connector base. The ball-and-socket joint includes a substantially rigid male ball connector formed with a substantially spherically convexly curved outer surface, a female socket adapted to receive the male ball connector rotatably therein, the female socket formed with a substantially spherically concavely curved inner surface complementary to the outer surface of the male ball connector and communicating with an opening thereinto sized to receive the male ball connector therethrough with a snap fit, and a resilient biasing member that is compressible between the outer surface of the male ball connector and the complementary inner surface of the female socket. A substantially rigid column is positioned between the mounting base and the connector base, the column having the male ball connector positioned adjacent to one end thereof.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of a novel mounting apparatus having interconnectable articulated elements;

FIG. 2 illustrates the novel mounting apparatus having a pliantly conformable mounting pad which is flexible for substantially conforming to curved or other substantially nonplanar mounting surface;

FIG. 3 illustrates a novel ball-and-socket joint of the a novel mounting apparatus;

FIG. 4 is a view of a mounting base portion of the novel mounting apparatus having a pliantly conformable mounting pad;

FIG. 5 illustrates one exemplary embodiment of a rigid foot structured for having the pliantly conformable mounting pad overmolded thereon;

FIG. 6 and FIG. 7 are views of an alternative novel mounting apparatus having interconnectable articulated elements;

FIG. 8 is a partial cross-section view of the alternative novel mounting apparatus showing details of the ball-and-socket joint; and

FIG. 9 is a cross-section view of a railing mounting base showing an inner surface of the female socket structured for receiving and retaining therein an o-ring biasing member.

### DETAILED DESCRIPTION OF PREFERRED EMBODIMENT

In the Figures, like numerals indicate like elements.

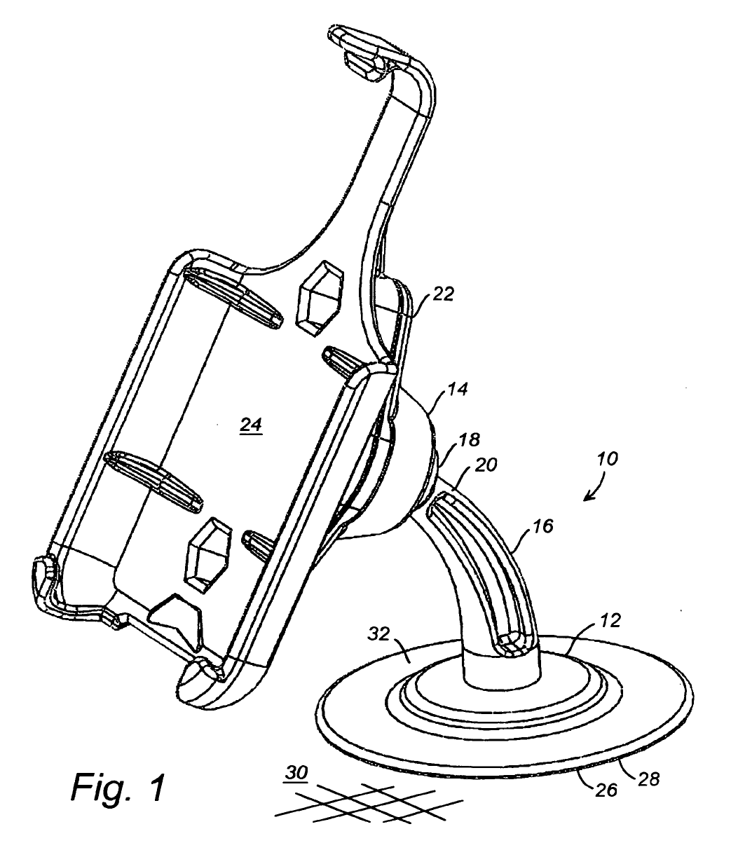

FIG. 1 illustrates a novel mounting apparatus 10 having interconnectable articulated elements, the interconnectable articulated elements including a mounting base 12 and a connector base 14. Connector base 14 is spaced away from mounting base 12 by a substantially rigid column 16. A ball-and-socket joint 18 is formed between mounting base 12 and connector base 14. For example, ball-and-socket joint 18 is formed between connector base 14 and a reduced neck portion 20 of column 16 distal from mounting base 12. Connector base 14 includes a mounting plate 22 for mounting an external object 24, such as but not limited to an instrument cradle.

Mounting base 12 includes a mounting pad 32 having means 26 on its under surface 28 for coupling to a mounting surface 30 external of mounting apparatus 10. By example and without limitation, coupling means 26 is a coupling agent such as an adhesive. For example, coupling means 26 is a conventional pressure sensitive adhesive, or PSA, of a type which forms a bond when pressure is applied to marry the adhesive with the adhered.

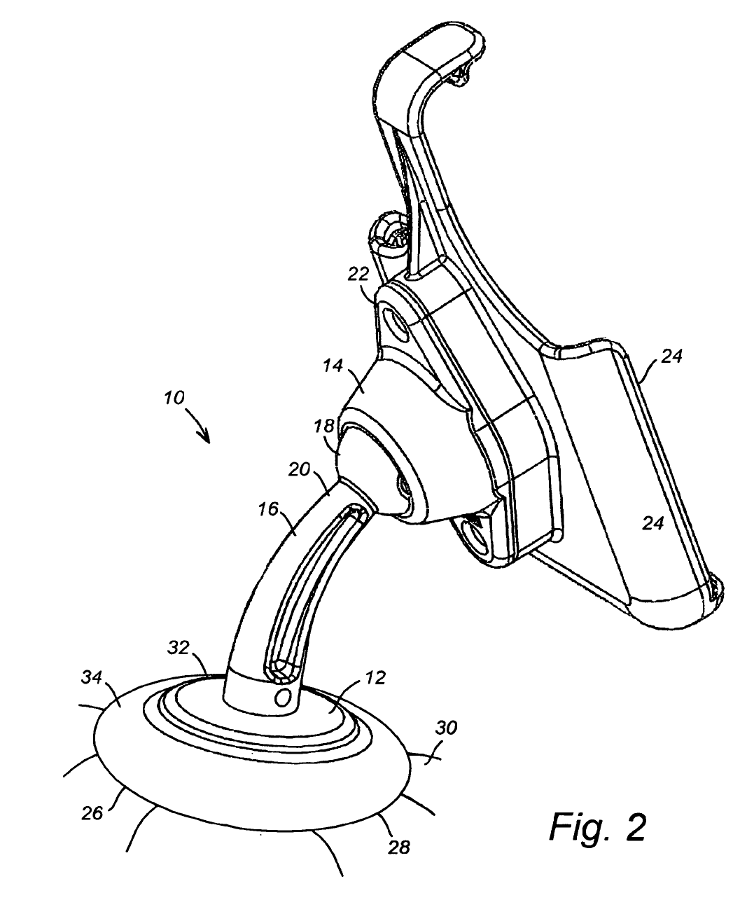

FIG. 2 illustrates mounting base 12 having a mounting pad 32 with a pliantly conformable outer skirt portion 34 which is flexible for substantially conforming to mounting surface 30 external of mounting apparatus 10 when surface 30 is a curved or other substantially nonplanar mounting surface, such as vehicle dashboard or other nonplanar surface. When conformable outer skirt portion 34 is conformed to nonplanar external surface 30, mounting pad 32 is adhered to surface 30 by coupling means 26 on its under surface 28.

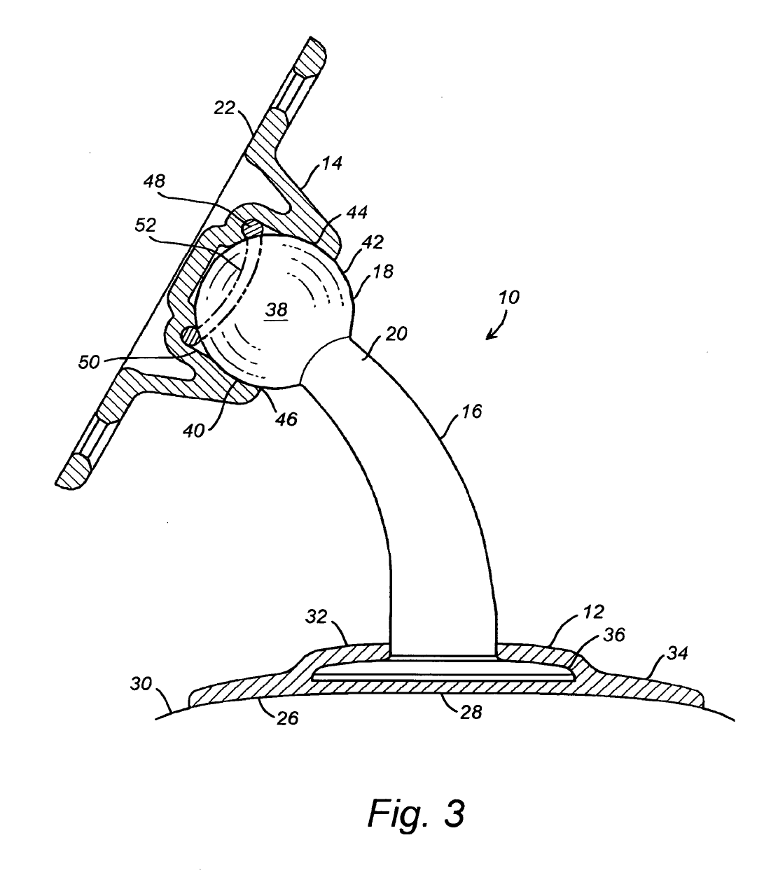

FIG. 3 illustrates mounting pad 32 of mounting base 12 having pliantly conformable outer skirt portion 34 (shown in cross-section) configured as a substantially flexible material. Mounting pad 32 is coupled to a substantially rigid foot 36 of mounting base 12 adjacent to one end of column 16. For example, mounting pad 32 is adhered to foot 36, or mounting pad 32 is overmolded onto foot 36.

FIG. 3 also illustrates ball-and-socket joint 18 between mounting base 12 and connector base 14, wherein male ball connector 38 is presented on reduced neck portion 20 of column 16 opposite from mounting base 12. Ball-and-socket joint 18 between mounting base 12 and connector base 14 is formed of interconnectable articulated inserting and receiving elements: the inserting element being a substantially spherically convexly curved male ball connector 38, and the receiving element being a complementary substantially spherically concavely curved female socket 40 adapted to receive male ball connector 38. Male ball connector 38 is formed with a part-spherical outer surface 42 and female socket 40 is formed with a part-spherical inner surface 44 communicating with an opening 46 thereinto. Part-spherical inner surface 44 of female socket 40 fits slideably over part-spherical outer surface 42 of male ball connector 38. Male ball connector 38 is more resistant to radial deformation than female socket 40, whereby male ball connector 38 is received within female socket 40 through opening 46 with a snap fit which provides load bearing support for loads transmitted through connector base 14. However, when male ball connector 38 is engaged in female socket 40, ball-and-socket joint 18 is capable of unlimited axial rotation and limited universal radial movement within limits of size differential between reduced neck portion 20 of column 16 and socket opening 46.

Additionally, one or more areas of interference contact are provided between male ball connector inserting element 38 and female socket receiving element 40. Here, an elastically compressible biasing member 48, such as an o-ring or compression spring, is provided between male ball connector 38 and female socket 40. Biasing member 48 is compressed by insertion force of male ball connector 38 being inserted into female socket 40, and the compression of biasing member 48 is maintained by socket opening 46 being closed about outer surface 42 of male ball connector 38. Accordingly, biasing member 48 compresses outer surface 42 of male ball connector 38 against inner surface 44 of female socket 40 that forms a snug fit of male ball connector 38 within female socket 40, which results in frictional forces between outer surface 42 of male ball connector 38 and inner surface 44 of female socket 40 that resists both rotational and radial movement of ball-and-socket joint 18.

Furthermore, when biasing member 48 is an elastically compressible elastomeric o-ring, surface friction between partially compressed o-ring biasing member 48 and outer surface 42 also resists movement of male ball connector 38 within female socket 40.

A seat 50 is provided for biasing member 48 for maintaining relative positioning against drag caused by movement of male ball connector 38 within female socket 40. By example and without limitation, seat 50 is formed in inner surface 44 of female socket 40. Connector base 14 (shown in cross-section) is formed with seat 50 as a groove sized to receive o-ring biasing member 48 to a depth that retains relative positioning of o-ring biasing member 48, yet causes a portion of o-ring biasing member 48 to partially protrude into female socket 40. The protruding portion of o-ring biasing member 48 engages outer surface 42 of male ball connector 38 and is compressed thereby. Accordingly, protruding portion of o-ring biasing member 48 forms a substantially circular area 52 (phantom lines) of interference contact with outer surface 42 of engaged male ball connector 38 wherein frictional drag occurs.

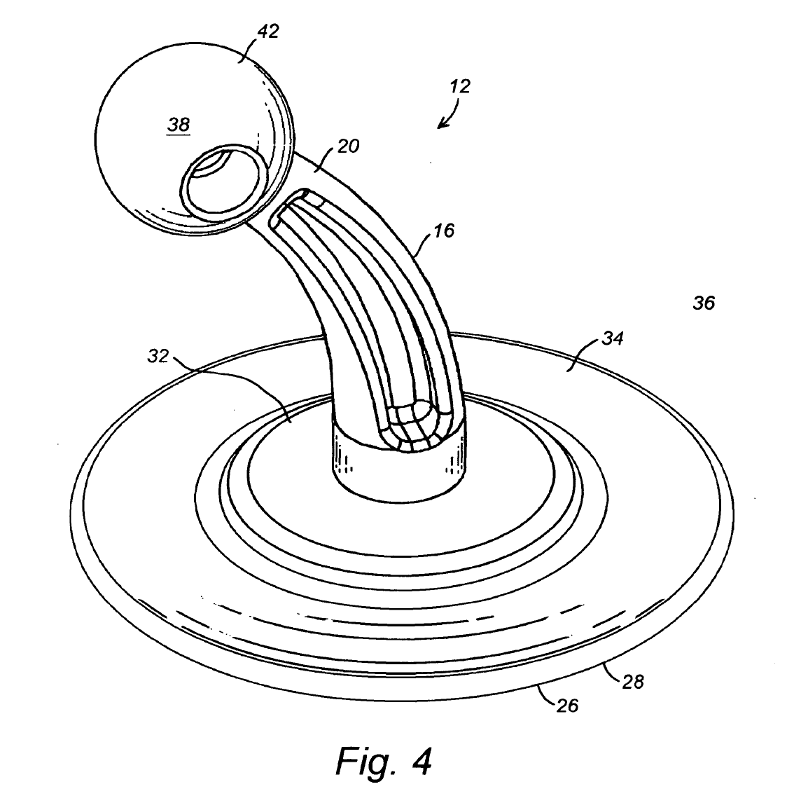

FIG. 4 is a view of mounting base 12 having overmolded mounting pad 32 adjacent to one end of column 16, and male ball connector 38 presented on reduced neck portion 20 at other end of column 16 distal from mounting base 12.

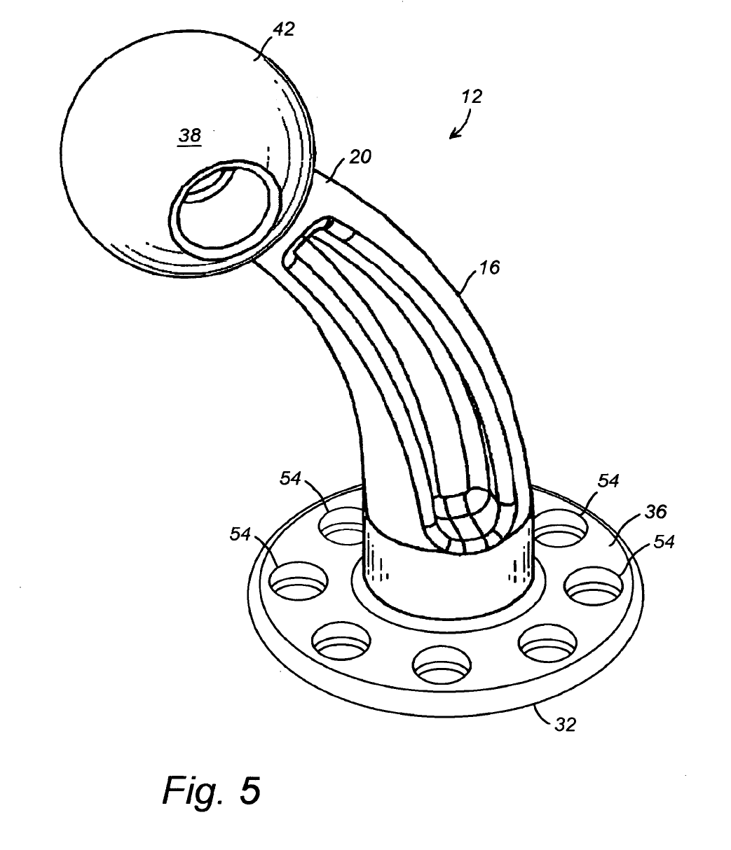

FIG. 5 illustrates mounting base 12 having one possible embodiment of substantially rigid foot 36 adjacent to one end of column 16. Here, foot 36 is optionally formed with a plurality of apertures 54 for retaining mounting pad 32 when overmolded thereon.

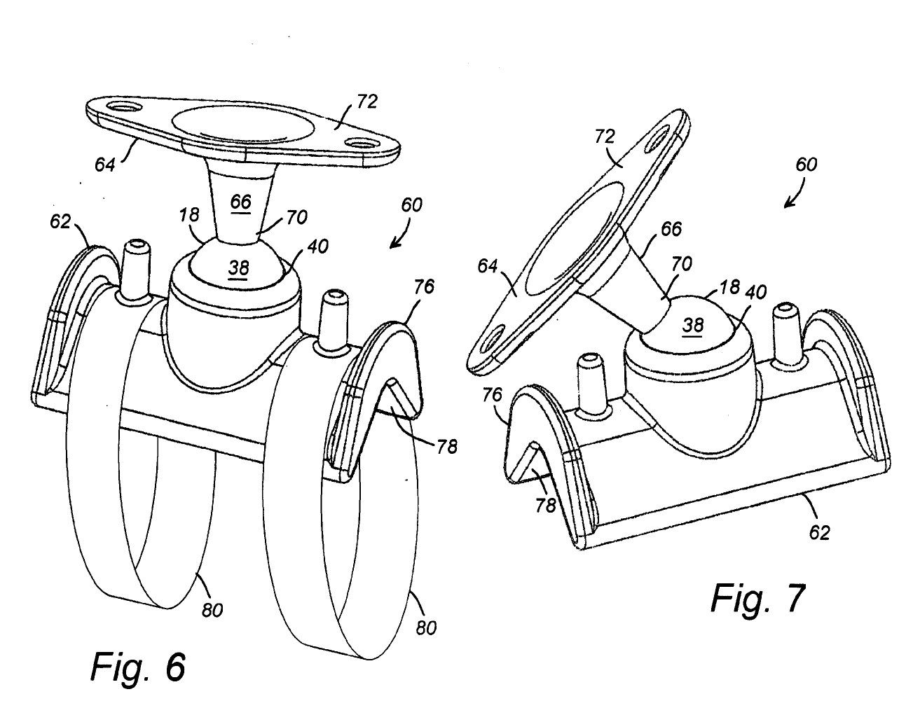

FIG. 6 and FIG. 7 are views of another novel mounting apparatus 60 having interconnectable articulated elements, the interconnectable articulated elements including a mounting base 62 adapted for mounting to a railing, and a different connector base 64. Connector base 64 is spaced away from railing mounting base 62 by a substantially rigid column 66. Ball-and-socket joint 18 is formed between mounting base 62 and connector base 64. For example, ball-and-socket joint 18 includes male ball connector 38 presented on a reduced neck portion 70 of column 66 distal from mounting base 62, and female socket 40 formed in connector base 64. FIGS. 6 and 7 illustrate mounting base 62 and connector base 64 rotated into different relative orientations by means of intervening ball-and-socket joint 18.

Connector base 64 includes a mounting plate 72 for mounting an external object 24 (shown in FIGS. 1, 2). Mounting base 62 includes a substantially rigid mounting pedestal 76 having a substantially V-shaped under surface 78 adapted for substantially conforming to a mating external rectangular or curved railing, and means 80 for coupling mounting pedestal 76 to the railing. By example and without limitation, coupling means 80 is one or more straps for wrapping around the external railing.

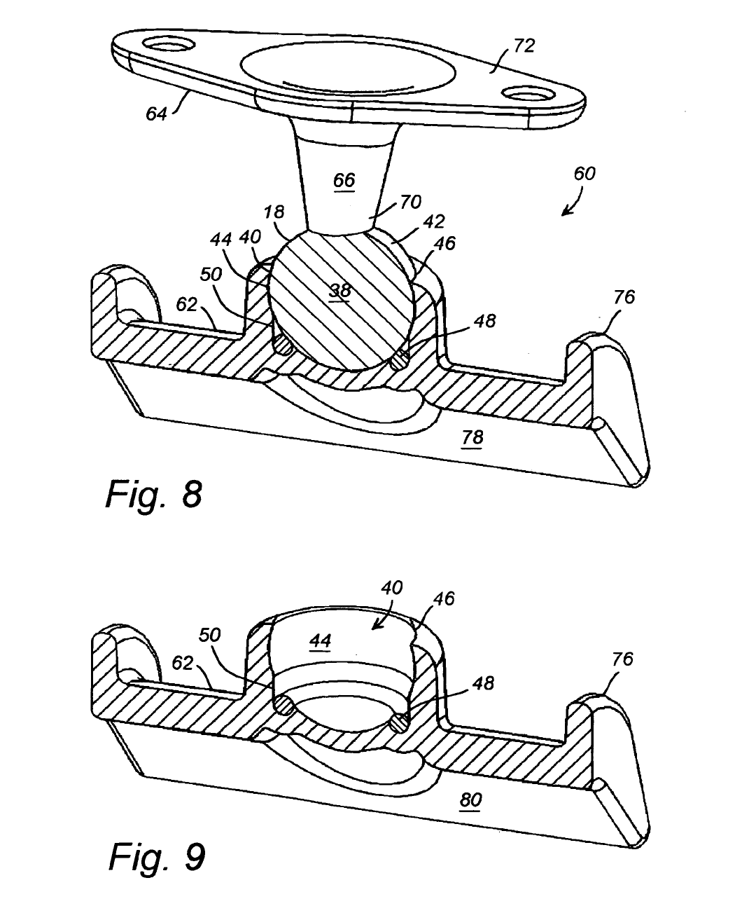

FIG. 8 is a partial cross-section view of novel mounting apparatus 60 showing ball-and-socket joint 18 formed between railing mounting base 62 and connector base 64. Elastically compressible o-ring or compression spring biasing member 48 is provided between male ball connector 38 and female socket 40. Biasing member 48 compresses outer surface 42 of male ball connector 38 against inner surface 44 of female socket 40. When biasing member 48 is an elastically compressible elastomeric o-ring, as shown here, surface friction between partially compressed o-ring biasing member 48 and outer surface 42 resists movement of male ball connector 38 within female socket 40.

FIG. 9 is a cross-section view of railing mounting base 62 showing inner surface 44 of female socket 40. Here, o-ring biasing member 48 is installed in seat 50 formed as a groove sized to receive o-ring biasing member 48 to a depth that retains relative positioning of o-ring biasing member 48, yet causes a portion of o-ring biasing member 48 to partially protrude into female socket 40. Accordingly, the protruding portion of o-ring biasing member 48 must be compressed by outer surface 42 of male ball connector 38 when it is engaged with female socket 40.

While the preferred and additional alternative embodiments of the invention have been illustrated and described, it will be appreciated that various changes can be made therein without departing from the spirit and scope of the invention. Accordingly, the inventor makes the following claims.

What is claimed is:

1. A mounting apparatus having interconnectable articulated elements, comprising:
a mounting base;
a connector base; and
a ball-and-socket joint between the mounting base and the connector base, the ball-and-socket joint comprising:
a male ball connector,
a complementary female socket adapted to receive the male ball connector, and
a biasing member compressible between the male ball connector and the female socket.

2. The mounting apparatus of claim 1, wherein the mounting base further comprises a substantially pliantly conformable mounting pad.

3. The mounting apparatus of claim 2, wherein the mounting pad further comprises a means for coupling a surface thereof to a surface external of the mounting apparatus.

4. The mounting apparatus of claim 3, wherein the coupling means further comprises a coupling agent resident on the surface thereof.

5. The mounting apparatus of claim 4, wherein the coupling agent further comprises an adhesive.

6. The mounting apparatus of claim 5, wherein the adhesive coupling agent further comprises a pressure sensitive adhesive.

7. The mounting apparatus of claim 1, wherein one of the male ball connector and the complementary female socket further comprises a seat structured for retaining the biasing member.

8. The mounting apparatus of claim 7, wherein the biasing member further comprises an o-ring, and the seat further comprises a groove formed in one of the male ball connector and the female socket.

9. The mounting apparatus of claim 1, wherein the mounting base further comprises a substantially rigid mounting pedestal adapted for mating to a rectangular or curved railing surface external of the mounting apparatus.

10. A mounting apparatus having interconnectable articulated elements, comprising:
a mounting base structured for substantially conforming to a surface external of the mounting apparatus;
a connector base, comprising a mounting plate; and
an interconnectable articulated ball-and-socket joint between the mounting base and the connector base, the ball-and-socket joint comprising:
a substantially spherically convexly curved male ball connector,
a complementary substantially spherically concavely curved female socket adapted to receive the male ball connector rotatably therein, and
a resilient biasing member compressible between the male ball connector and the female socket.

11. The mounting apparatus of claim 10, further comprising a substantially rigid column between the mounting base and the connector base, the column having the male ball connector positioned adjacent to one end thereof.

12. The mounting apparatus of claim 10, wherein the female socket further comprises a seat structured for receiving the biasing member and sized such that, when the biasing member is further resident in the seat, the biasing member partially protrudes into the socket in a compressed relationship with the male ball connector.

13. The mounting apparatus of claim 12, wherein the biasing member further comprises an elastomeric o-ring sized to be received partially into the seat and substantially retained therein.

14. The mounting apparatus of claim 11, wherein the mounting base further comprises a substantially pliantly conformable mounting pad having a means for adhesively adhering to a nonplanar surface external of the mounting apparatus.

15. The mounting apparatus of claim 14, wherein the means for adhesively adhering to a nonplanar surface external of the mounting apparatus further comprises a pressure sensitive adhesive resident on an under surface of the mounting pad.

16. A mounting apparatus having interconnectable articulated elements, comprising:
a mounting base structured for substantially conforming to a surface external of the mounting apparatus;
a connector base, comprising a mounting plate;
an interconnectable articulated ball-and-socket joint between the mounting base and the connector base, the ball-and-socket joint comprising:
a substantially rigid male ball connector comprising a substantially spherically convexly curved outer surface,
a female socket adapted to receive the male ball connector rotatably therein, the female socket comprising a substantially spherically concavely curved inner surface complementary to the outer surface of the male ball connector and communicating with an opening thereinto sized to receive the male ball connector therethrough with a snap fit, and
a resilient biasing member compressible between the outer surface of the male ball connector and the complementary inner surface of the female socket; and
a substantially rigid column between the mounting base and the connector base, the column having the male ball connector positioned adjacent to one end thereof.

17. The mounting apparatus of claim 16, wherein the inner surface of the female socket further comprises a grooved seat sized to receive the resilient biasing member partially thereinto with a portion thereof protruding into an interior of the female socket in interference with the male ball connector engaged therewith.

18. The mounting apparatus of claim 17, wherein the biasing member further comprises an elastomeric o-ring sized to be received partially into the grooved seat and substantially retained therein.

19. The mounting apparatus of claim 18, wherein the mounting base further comprises a substantially pliantly conformable mounting pad having a pressure sensitive adhesive resident on an under surface thereof for adhesively adhering to a nonplanar surface external of the mounting apparatus.

20. The mounting apparatus of claim 18, wherein the mounting base further comprises a substantially rigid mounting pedestal comprising a substantially V-shaped under surface adapted for mating to a rectangular or curved railing surface external of the mounting apparatus.
